(19) United States
(12) Patent Application Publication
(10) Pub. No.: US 2026/0299625 A1
(43) Pub. Date: Oct. 1, 2026

(54) Apparatus for the Control of a Flow of a Liquid

(71) Applicant: Jason Richardson, Pockington (GB)

(72) Inventor: Jason Richardson, Pockington (GB)

(21) Appl. No.: 19/479,803

(22) PCT Filed: May 7, 2024
(86) PCT No.: PCT/GB2024/051186

§ 371 Date: Oct. 29, 2025

(30) Foreign Application Priority Data
May 5, 2023 (GB) 2306659.0

(51) Int. Cl. G05D 9/02; E03C 1/04; F16K 31/18

(52) U.S. Cl. CPC G05D 9/02; E03C 1/0401; F16K 31/18

(57) ABSTRACT

Apparatus to automatically control the flow of a liquid between a source and an end use location such as a container which is being filled. The apparatus includes an inlet connectable to a source of said liquid passing to one or more outlets via which the liquid, when permitted, flows to the end use location, wherein the apparatus includes a valve assembly for the prevention of the flow of liquid from the apparatus when moved to a closed position under the influence of a movable body in a housing that moves in reaction to the level and/or pressure of the liquid which has entered the housing.

The invention to which this application relates is apparatus of a type which can be utilised to control the flow of a liquid between a source of the water such as, for example, a tap, and an end use location such as, for example, a container which is being filled. The apparatus is provided to be located intermediate of said source and end use location so as to allow the control of the flow of water and, in particular to prevent the overflow of the liquid even when a person may not be present.

The invention is particularly directed towards preventing the overflow of water from a water supply such as from a mains tap into a container such as a trough or bucket and the invention is now described with respect to that use. However it should be appreciated that the apparatus as herein described can be of use with other forms of liquid and in other areas of use and such uses are within the scope of this patent application.

The filling of an end use location such as a container, with water to allow the water to be available for subsequent use and/or to act as a drinking source for animals, is well-known. Also known is the problem that in in order to prevent the water overflowing from the container if the water continues to be supplied after the container is full, a person has to be present during the filling operation in order to ensure that the container is filled to the required level whilst, at the same time, preventing the overflowing and continued flow of water from the water source even when the container has already been filled and thereby prevent wastage of water by switching off the supply and/or removing the source such as a hose from the container. These issues, in conjunction with the person being required to be present during the filling operation which, in many instances, can be repeatedly required to be performed for a number of containers in any given day, such as for example, in a horse stables, means that there can be a significant amount of time required to be spent by a person monitoring the water flow which again adds to additional expense to the end user of the water.

This is an increasing problem when one considers that many water supplies are now metered so that the user is charged in accordance with their use of the water supply and therefore, if the water is wasted, this represents additional, and unnecessary, expense to the end user. Furthermore, there are considerable environmental concerns about the security of the water supply terms of availability, especially in summer months or drier countries and/or in terms of potential contamination. As a result it is increasingly necessary for both the water supplier and the end user to be able to show that they are managing the supply of water in an economical and environmentally beneficial manner.

Whilst it is known to be able to provide apparatus which prevents the flow of water once a particular level of water has been reached, the known apparatus is typically required to be permanently fitted in position as part of the container and water piping and therefore limits its wider scale use.

The aim of the present invention is to provide apparatus which allows the management of a flow of liquid into an end use location such as a container so as to prevent any significant overflow and wastage of the liquid. A further aim is to provide the apparatus in a form which allows the same to be portable and therefore caried and used at different location and with different containers. A further aim is to allow the control of the flow of water to be achieved by the apparatus with no requirement for human intervention or presence at the apparatus.

In a first aspect of the invention, there is provided apparatus for use in the automatic control of a flow of a liquid from a liquid source into an end use location, said apparatus including a cap portion with an inlet connectable to said liquid source, a housing attached to or provided as part of said cap portion and one or more outlets via which the liquid, when permitted, flows from the apparatus into said end use location wherein said housing includes a moveable body located therein, said housing including one or more ports which allow liquid from the end use location, when at and above the level of said one or more ports, to enter the housing and cause the moveable body to move linearly with said housing from an open position in which said liquid is permitted to flow through the said one or more outlets, towards a closing position in which the flow of said liquid through the said one or more outlets is prevented by a valve assembly in a closed position.

Typically the housing, moveable body and cap portion are substantially in-line.

In one embodiment the moveable body moves in reaction to the level and/or pressure of liquid located within the housing at an instant of time, such that when the level and/or pressure reaches a predetermined level, the moveable body is in the closing position and actuator means on the said moveable body are at a location to cause a valve assembly to close and prevent the supply of liquid through the said outlets.

Typically the cap portion, inlet, moveable body valve assembly and/or housing are located substantially in line.

Typically, the housing is located in said container at a selected, and, in one embodiment, fixed location for that use such that when the liquid in the container reaches the level of the said ports, the liquid starts to enter the housing through the said ports and if the level of liquid in the container continues to rise so the moveable body within the housing is moved substantially linearly, and typically upwardly as a greater amount of liquid enters the housing until the moveable body reaches the closing position and hence causes the actuator to move the valve assembly to the closed position and thereby prevent any further liquid from the liquid source passing through the apparatus into the container and so sets the level at which the liquid flow is stopped so as, for example, to prevent overflow.

Typically, the said apparatus includes a location means which locates the apparatus with respect to the container and, in particular, the location of the housing at a level so as to define the predetermined level to which the container is to be filled with the liquid.

In one embodiment, the location means extends from at least one side of the housing in a substantially perpendicular direction so that, for example, the said longitudinal axis of the housing is substantially vertical and offset from a side wall of the said container when the apparatus is in use.

In one embodiment, the inlet is provided to be connected to a liquid source in the form of a hosepipe or tap. In one embodiment the location means includes a retainer so as to allow a portion of a hosepipe to be located therewith. In one embodiment the said connection is releasable and a conventional hosepipe connection can be used.

Typically the location means is releasably connectable to the said container so as to allow the apparatus to be portable and be used at different locations, with different liquid supplies and/or different containers. In one embodiment the said apparatus can remain in situ with the hosepipe during use of the hosepipe for different purposes.

In one embodiment, the apparatus can be adjusted to allow the same to operate with different liquid source pressures or alternative versions of the same apparatus may be provided to be selectively used with specific liquid pressure sources.

Typically the valve assembly includes a resilient flange member which allows the movement of a valve member between the open and closed positions. Typically the actuator of the moveable body contacts with the valve member to move the same to the closed position.

In one embodiment the said source of the liquid is a mains water supply.

Thus, there is provided a means of controlling the flow of liquid from a liquid source to be achieved, such that the flow of liquid can be stopped when the level of liquid in a container with which the apparatus is being used reaches a predetermined level which is determined by the relative position of the apparatus and the container. At the same time, the current invention allows the same to be achieved in a relatively confined area or space.

Specific embodiments of the invention are now described with reference to the accompanying drawings wherein:

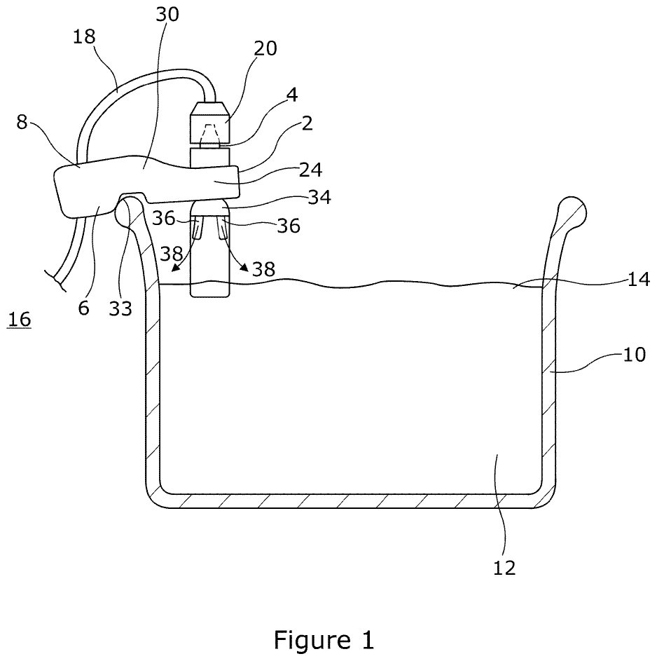

FIG. 1 illustrates apparatus in accordance with one embodiment of the invention in use;

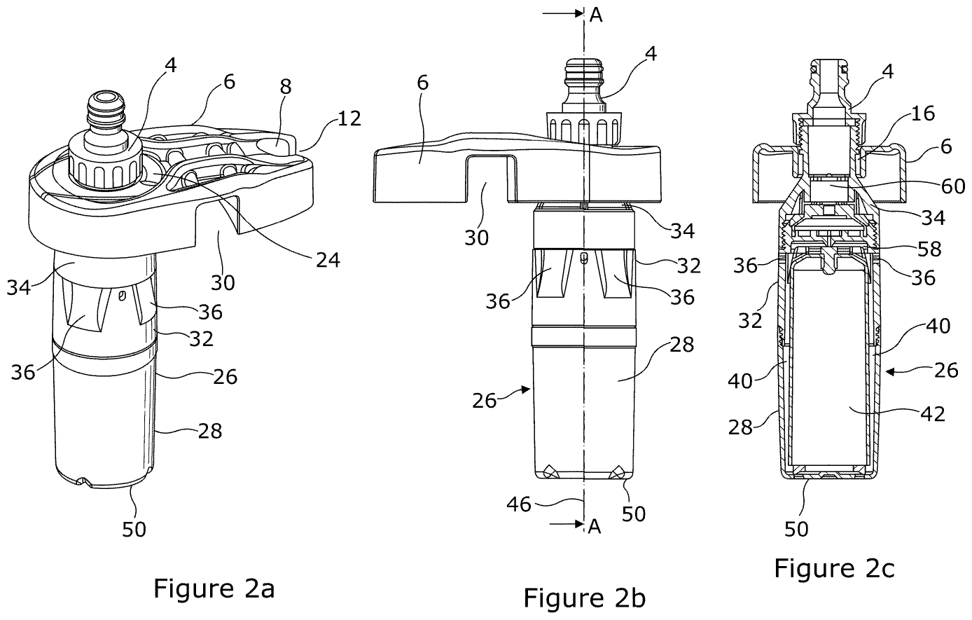

FIGS. 2a-c illustrate the apparatus of FIG. 1 in an assembled condition with a locating means;

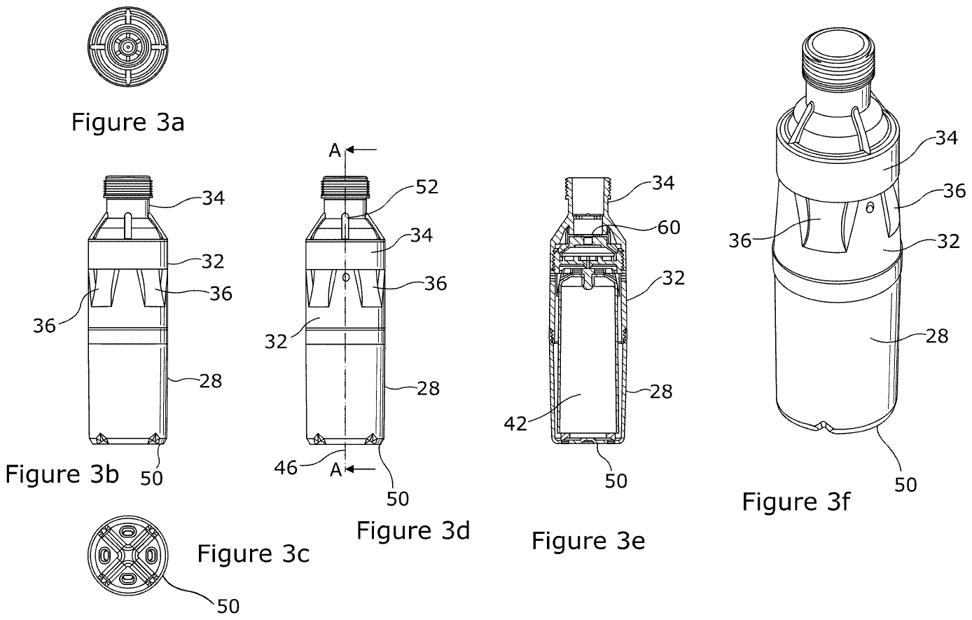

FIG. 3a-f illustrate the housing, cap portion, valve assembly and moveable body of the apparatus of FIGS. 2a-c;

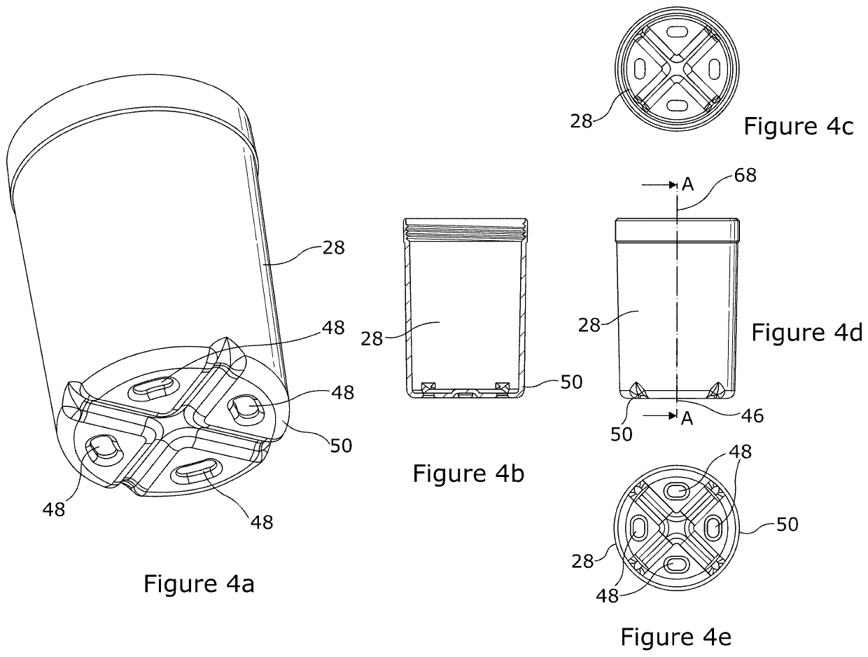

FIGS. 4a-e illustrates the lower part of the housing in accordance with one embodiment of the invention;

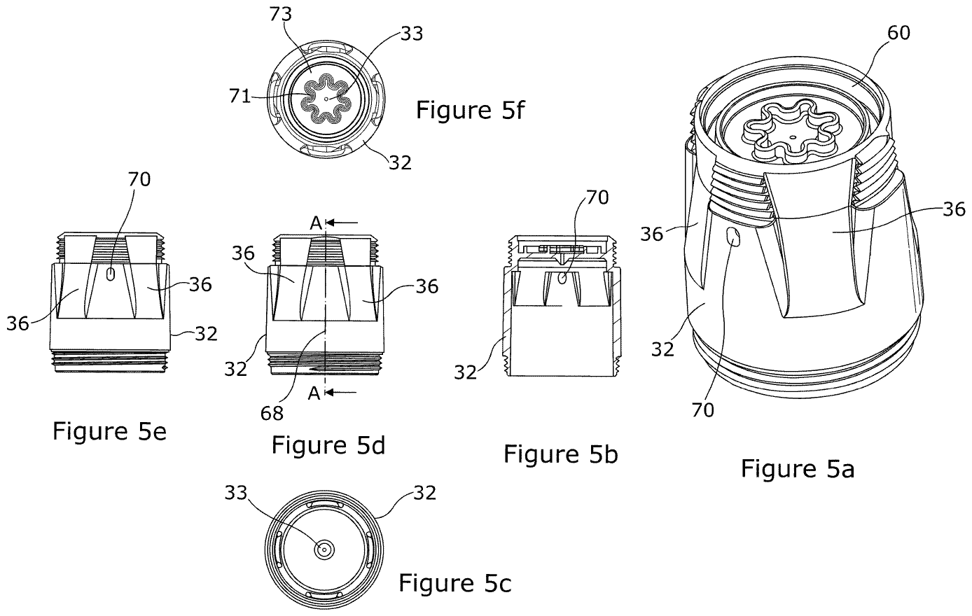

FIGS. 5a-f illustrate the top part of the housing in accordance with one embodiment of the invention;

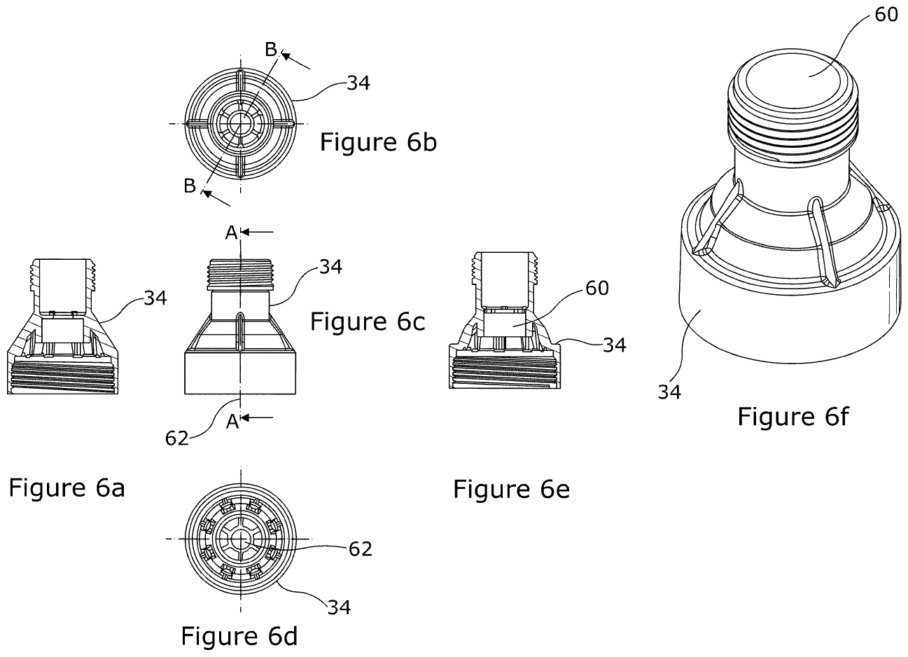

FIGS. 6a-f illustrates the cap portion of the apparatus in one embodiment;

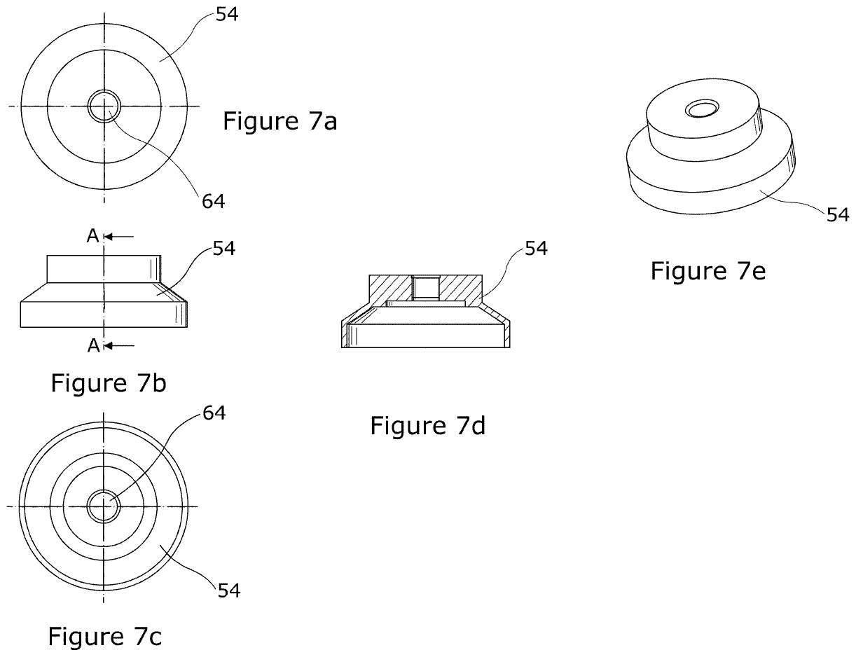

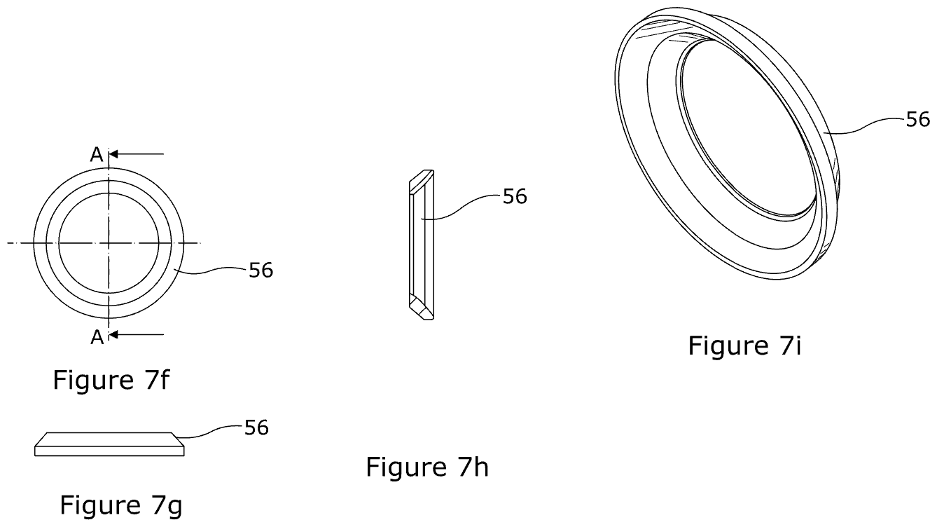

FIGS. 7a-i illustrate one embodiment of the valve assembly;

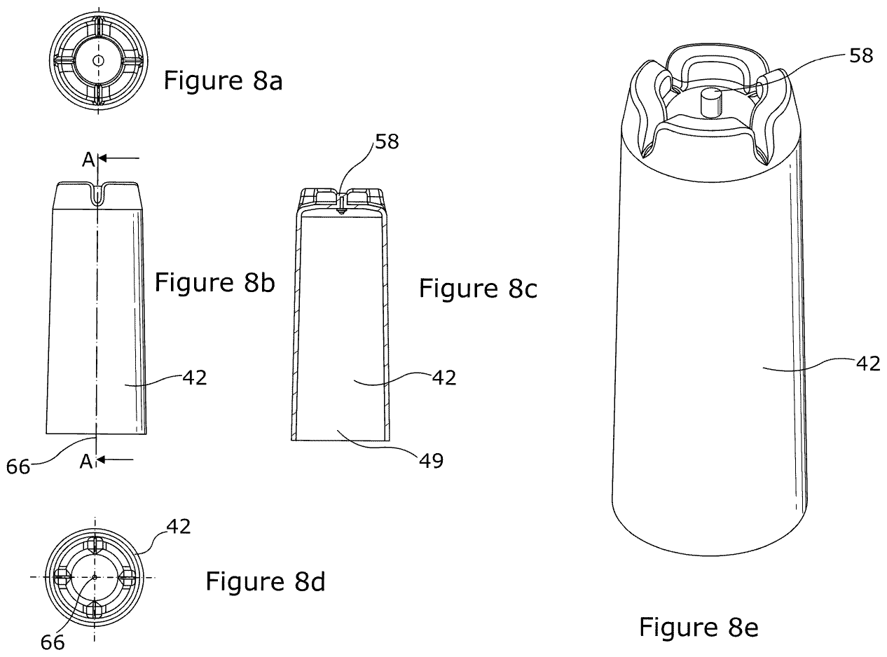

FIGS. 8a-e illustrate illustrates the moveable body of the apparatus in accordance with one embodiment of the invention;

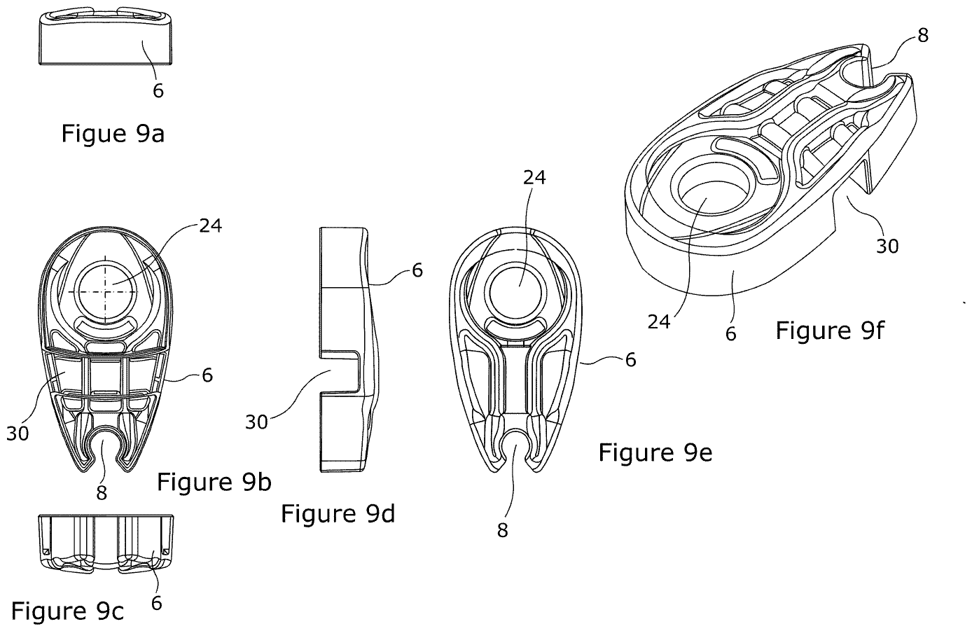

FIGS. 9a-f illustrate the locating means in accordance with one embodiment of the invention;

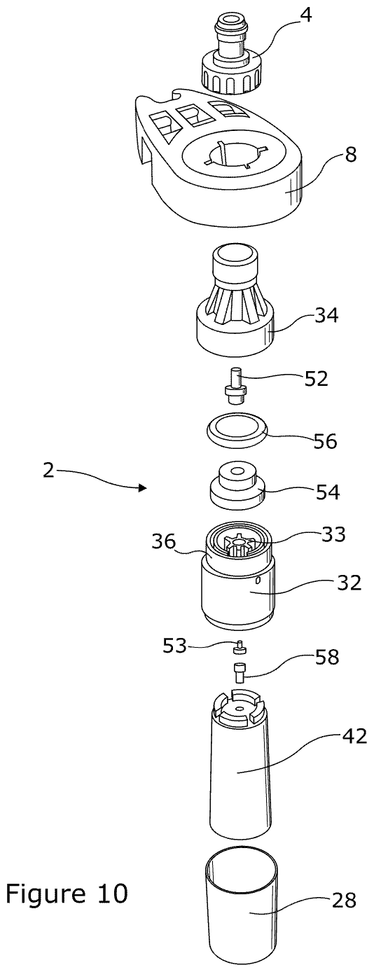

FIG. 10 illustrates an exploded view of the apparatus in accordance with one embodiment of the invention;

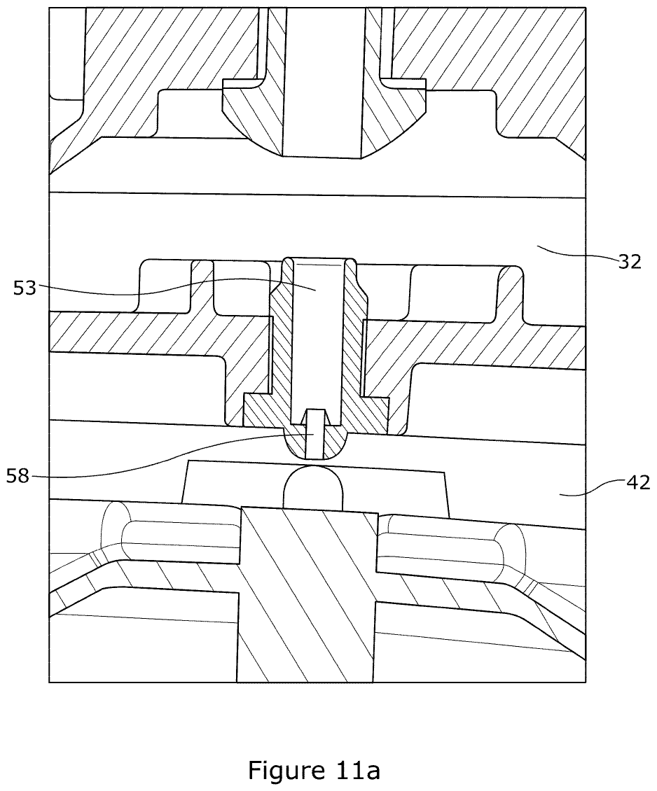

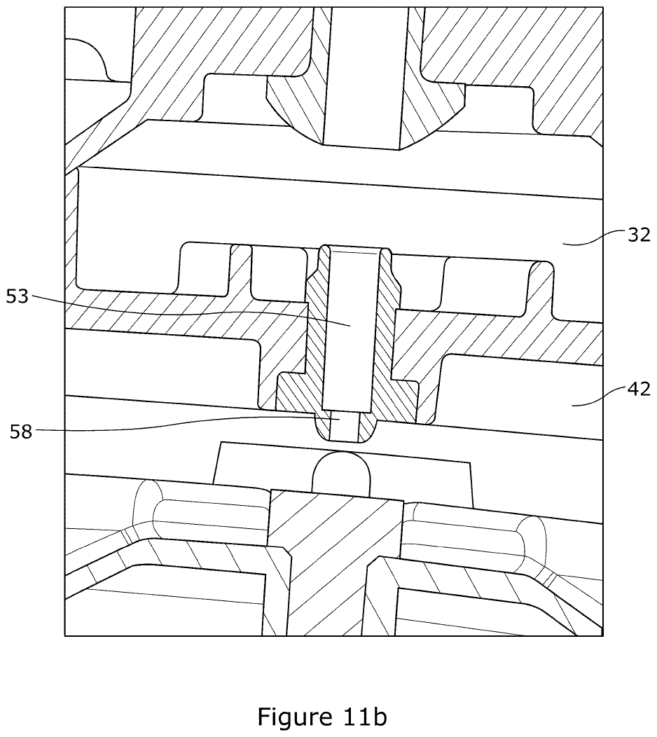

FIGS. 11a-b illustrate detail views of various valve assemblies in accordance with various embodiments of the invention;

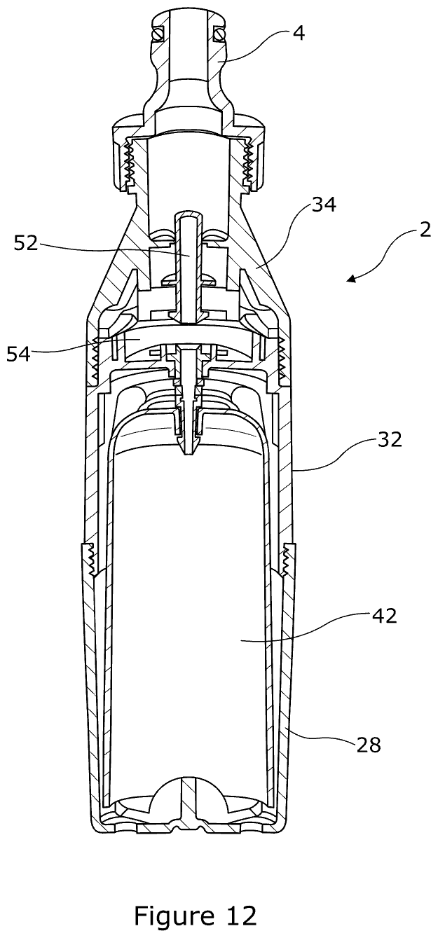

FIG. 12 illustrates the apparatus in a closed configuration in accordance with one embodiment of the invention; and

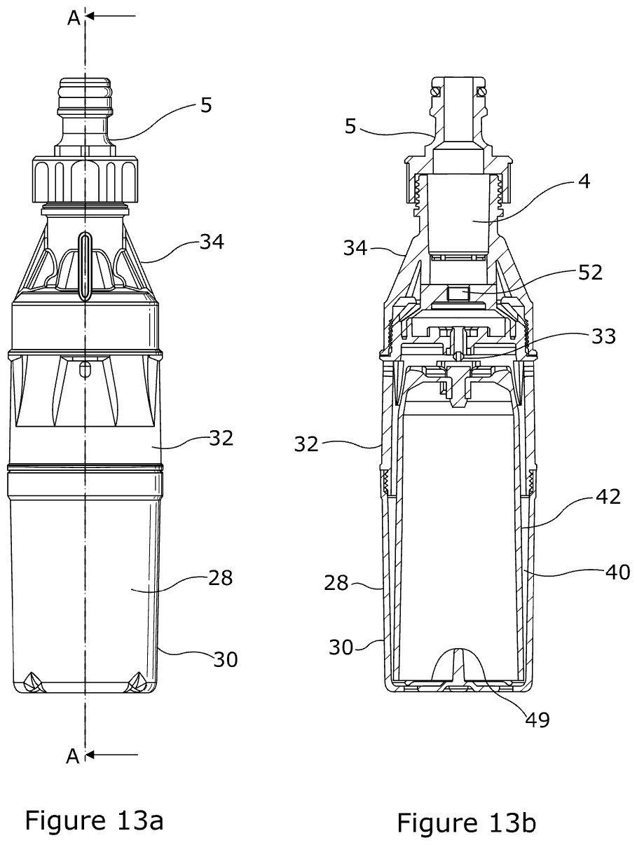

FIGS. 13a and b provide further detail of one embodiment of the invention.

Referring now to FIG. 1 there is illustrated in a schematic manner apparatus in accordance with the invention at a location of use on a container 10 which is shown in cross section and which has a cavity 12 to be filled with water 14 from a mains water source 16 via a pipe 18. The apparatus is shown in more detail in FIGS. 2a-c and FIGS. 3a-f and FIGS. 13a-b. The apparatus includes a cap portion 34 shown in more detail in FIGS. 6a-f, with an inlet 4 and the cap portion is engaged with a hose pipe connection 20 of the hosepipe 18. The cap portion 34 may be provided with a connection 5 of any suitable form such as, as shown, in the form of a plug connection at one end provided to receive thereon said hosepipe socket connection 20 and at the other end a threaded connection to the cap portion 34. The apparatus can be selectively used with location means and in this embodiment the location means 6 are shown in position with the apparatus in FIGS. 1 and 2a-c and the location means are shown in more detail in FIGS. 9a-f. The location means 6 is typically a unitary structure and includes a passage 24 in which the cap portion 34 is located, a locator 8 for the hosepipe 18 and a locator recess 30 to allow the location means and hence apparatus to be removably located with respect to the container, such as on the edge 22 of the container 10 as shown and thereby allow the secure location of the apparatus with the container which is being filled with water and to provide the apparatus in a substantially fixed position or in a position range.

The apparatus also includes a housing 26 which is formed of a lower part 28 shown in more detail in FIGS. 4a-e, connected to a top part 32 shown in more detail in FIGS. 5a-f and which is connected to the cap portion 34. The cap portion has a threaded engagement with the top part 32 of the housing which is formed so as to have outlet ports 36 at the interface between the cap portion 34 and the top part 32 which act as outlets as they allow, when the valve assembly of the apparatus is open, water to pass from the inlet 4 through the cap portion and out of the outlets 36 and into the container cavity 12 as indicated by arrows 38 in FIG. 1 and so allow the filling of the container with water.

The top and lower parts 28, 32 of the housing are hollow and therefore, when joined together, form a cavity 40 and in which a moveable body 42 is located and which is shown in detail in FIGS. 8a-e. The moveable body 42 is located in the housing as an inverted chamber with an opening 49 located towards the base 50 of the housing 26.

An exploded diagram of the components and their relationship is shown in FIG. 10. A valve assembly member 52 is located with a resilient valve body 54, illustrated in FIGS. 7a-e. The valve assembly member 52 and valve body 54 are located with the upper part 32 of the housing 26 by an annular ring 56, illustrated in FIGS. 7f-i. The valve assembly member 52 is configured to extend through the flow passage 60 of the cap portion 34 and plug the inlet 4 when the valve body 54 is flexed upwards to a closed or seal position and hence prevent water from reaching the outlet ports 36. When the valve body 52 is moved to an open position by the flow of water from the inlet and there is no resistance to that movement from the moveable body, the valve assembly member 52 is retracted from the inlet 4 and flow of water continues from the source inlet 4 to the outlet ports 36 and hence to the external location of use such as the container cavity 14.

A channel in the valve assembly member 52 enables a small quantity of the water to flow through to the underside of the valve body 54 when the valve body is located with the upper housing 32. A channel 33 in the top face of the upper housing part 32 enables water to flow from the underside of the valve body 54 to cavity 40.

During operation, water is supplied through the inlet 4 by the pipe 18 into the cap portion 34. The force of the water moves the valve body 54 towards the housing and the valve assembly member 52 is retracted from the inlet 4 so that water may flow through the cap portion 34 and through the outlet ports 36, as indicated by 38. Typically a small amount of water, air and/or a water and air mixture may flow through a restricted channel of the valve assembly member 52, through the valve body 54 and a restricted channel 33 of the upper housing 32 which is surrounded by a convoluted shaped wall 71 which when the valve body 54 is in an open position prevents any of the said water and/or air from passing outwardly away from the restricted channel 33 and into the recessed area 73 of the top face of the housing.

As the level of water in the container with which the apparatus is located, rises, the water will eventually reach ports 48 provided at the base of the lower part 28 of the housing 30. As the water level within the container 10 continues to rise rises and surrounds the apparatus 2, water will increasingly enter the cavity 40 through the ports 48 of the base 50. The buoyancy of the moveable body 42 in the cavity 40 will cause the body 42 to rise ad move linearly along the cavity 40 towards the channel 33. The body 42 is contained within the cavity so as to allow the same to move linearly, along the longitudinal axis 46 under the influence of the water as shown in FIGS. 4a-e. Channels 70 located at the top of upper housing 32 enable air to escape, such that water may freely rise within the cavity 40.

Once the body reaches a certain height within the cavity 40, then an actuator 58, located in the top wall of the moveable body 42, engages with a stop 53 of the channel 33, preventing the flow of water from the underside of the valve body 54. The flow of water through the valve assembly member 52 fills the underside of the valve body 54, flexing the valve body upwardly and hence engaging the valve assembly member 52 with the water flow passage 60 in the cap portion and closes and seals the same and so prevents the flow of water from the inlet 4 from passing to the outlets 36. In this embodiment this prevents any more water from passing into the container cavity 12 and so prevents the overflow of the container and continued uncontrolled flow of water from the hosepipe. In another example, the actuator 58 engages directly with the valve body 54 to flex the same. Various versions of the valve assembly are illustrated in FIGS. 11a-b.

Typically the longitudinal axis 62 of the cap portion 34, longitudinal axis 64 of the valve assembly 52, 54, 56, longitudinal axis 66 of the moveable body 42, and longitudinal axis 68 of the housing 26 are coaxial along the longitudinal axis 46 of the apparatus and the movement of the moveable body 42 is along the longitudinal axis 46 within the housing cavity 40 and this therefore allows a compact control apparatus to be provided to allow control and prevention of overflow of water to be achieved automatically and without the need for user intervention. Furthermore, it allows the control to be achieved without the need for the apparatus to be provided as an integral part of the water supply apparatus, thereby allowing the apparatus to be used in a relatively confined spaced and to also be transportable between different locations And provide an in-line water flow control apparatus as illustrated, for example in FIGS. 12 and 13a and b.

As the water level surrounding the apparatus decreases due to evaporation, the water being drunk by livestock or a combination of both, if the apparatus is located on a container for a period of time the moveable body 42 within the cavity 40 of the apparatus may move away from the channel 33 and disengage with the valve assembly and so the valve body 54 moves to an open position and water will resume flowing through the outlets 36 until the water is at a level to reclose the apparatus. In this way, the water level within the container may be automatically maintained by the apparatus, provided that the flow of water from the source 16 is maintained.

The invention therefore provides apparatus which allows for the in-line automatic control of the flow of liquid from a water source into an end use location such as a container which is being filled.

1. Apparatus for use in the automatic control of a flow of a liquid from a liquid source into an end use location, said apparatus comprising:
a cap portion with an inlet connectable to said liquid source,
a housing attached to or provided as part of said cap portion and one or more outlets via which the liquid, when permitted, flows from the apparatus into said end use location wherein said housing includes a moveable body located therein, said housing including one or more ports which allow liquid from the end use location, when at and above the level of said one or more ports, to enter the housing and cause the moveable body to move linearly with said housing from an open position in which said liquid is permitted to flow through the said one or more outlets, towards a closing position in which the flow of said liquid through the said one or more outlets is prevented by a valve assembly in a closed position.

2. Apparatus according to claim 1 wherein the housing, moveable body and cap portions are substantially in-line.

3. Apparatus according to claim 1 wherein the moveable body moves in reaction to the level and/or pressure of liquid located within a cavity in the housing at an instant of time.

4. Apparatus according to claim 3 wherein the moveable body includes a chamber with an opening positioned substantially at the end of the housing cavity opposing the cap portion such that the moveable body move towards the cap portion within the housing under its own buoyancy towards the said closing position.

5. Apparatus according to claim 1 wherein when the level of liquid reaches a predetermined level in the housing cavity and the moveable body has reached the closing position an actuator means on the said moveable body causes actuation of the valve assembly to close the supply of liquid through the said outlets.

6. Apparatus according to claim 1 wherein the valve assembly includes a resilient flange member which allows the movement of a valve member between the open and closed positions.

7. Apparatus according to claim 6, wherein the valve assembly has a longitudinal axis which is coaxial with a longitudinal axis of the housing and the movement of the moveable body and the valve member of the valve assembly are substantially linear along said longitudinal axes.

8. Apparatus according to claim 7 wherein the said longitudinal axes are co-axial and in-line with the inlet into said apparatus.

9. Apparatus according to claim 1, wherein the end use location is a container into which the liquid from the apparatus outlets flows and the housing is located in said container at a substantially fixed location for that use, wherein liquid is prevented from entering the container by the apparatus when the level of liquid within the container reaches a predetermined level set by the positioning of the apparatus housing with respect to the container.

10. Apparatus according to claim 9 wherein the apparatus includes a location means which allows the location of the apparatus with respect to the container into which the liquid from the apparatus outlets flows.

11. Apparatus according to claim 10 wherein the location means extends from at least one side of the housing in a substantially perpendicular direction to the housing of the apparatus such that the said longitudinal axis of the housing is substantially vertical and/or substantially parallel with the edge of the container.

12. Apparatus according to claim 10 wherein the location means includes a retainer so as to allow a portion of a liquid supply pipe connected to the inlet of the apparatus to be located therewith.

13. Apparatus according to claim 10 wherein the location means is releasably connectable to the said container and/or the apparatus so as to allow the apparatus to be portable and be used at different locations, with different liquid supplies and/or different containers.

14. Apparatus according to claim 1 wherein the apparatus can be adjusted to allow the same to operate with different liquid source pressures.

15. Apparatus according to claim 1 wherein liquid source is a mains water supply.

16. Apparatus according to claim 15 wherein the mains water supply is provided from a tap to a hosepipe and in turn the apparatus.
